(19) United States
(12) Patent Application Publication
(10) Pub. No.: US 2026/0114437 A1
(43) Pub. Date: Apr. 30, 2026

(54) FISHING REEL

(71) Applicant: GLOBERIDE, Inc., Tokyo (JP)

(72) Inventor: Taro IKE, Higashikurume-shi (JP)

(73) Assignee: GLOBERIDE, Inc., Tokyo (JP)

(21) Appl. No.: 19/307,152

(22) Filed: Aug. 22, 2025

(30) Foreign Application Priority Data
Oct. 29, 2024 (JP) 2024-189429

(51) Int. Cl. A01K 89/015

(52) U.S. Cl. CPC A01K 89/01931

(57) ABSTRACT

A fishing reel according to an embodiment of the present invention is a fishing reel comprising: a reel body provided with left and right side panels; a spool that is provided between the left and right side panels and comprises a line winding body around which a fishing line is wound by a winding operation of an operating part; and a spool shaft that is provided between the left and right side panels and has an outer peripheral face to which the spool is integrally fixed, and comprises a first pin embedded in the spool shaft and the spool to extend from the spool shaft to the spool, and a second pin configured to cover a first end of the first pin and fixed in the spool to extend from the spool to the spool shaft.

### CROSS-REFERENCE TO RELATED APPLICATION

This application claims priority under 35 U.S.C. § 119 to Japanese Patent Application No. 2024-189429 filed on October 29, 2024 in the Japanese Patent Office, the entire contents of each hereby incorporated by reference.

### BACKGROUND OF THE INVENTION

### 1. TECHNICAL FIELD

The present invention relates to a fishing reel.

### 2. DESCRIPTION OF THE RELATED ART

Conventionally, in a fishing reel including a reel body with a handle and a spool rotatably mounted to the reel body, there is known a structure in which the spool includes a line winding body and flanges provided at both ends of the line winding body, the line winding body has a cylindrical shape around which a fishing line is wound, each of the flanges has a diameter larger than an outer diameter of the line winding body, an inner peripheral portion of the line winding body is attached to a spool shaft, and a fishing line locking portion, configured to lock a winding start end of the fishing line wound around the line winding body, is provided on an outer periphery of the line winding body.

### SUMMARY OF THE INVENTION

In relation to such a fishing reel, for example, JP 2001-112385 A discloses a spool for a dual-bearing reel, the spool being supported to be rotatable respect to a reel body and attached to a spool shaft, the spool comprising: a line winding body having a recess and an outer periphery around which a fishing line is wound; flanges provided at both ends of the line winding body; and a locking pin having a fishing line locking portion having a proximal end that is embedded in a bottom face of the recess, and a distal end that locks the fishing line in the recess.

However, in the fishing reel in JP 2001-112385 A, when line cutting is performed by locking the spool shaft, closing a drag, or the like against a snag, particularly when the strength of the line is strong, idling occurs between the spool and the spool shaft, and there is a problem that a line stop pin embedded in the spool is broken or destroyed.

The present invention has been made in view of the above circumstances, and an object of the present invention is to provide a fishing reel capable of suppressing idling between a spool and a spool shaft even when strong tension is generated in the spool during fishing. Other objects of the present invention will become apparent upon reference to the entirety of the present specification.

A fishing reel according to an embodiment of the present invention is a fishing reel comprising: a reel body provided with left and right side panels; a spool that is provided between the left and right side panels and comprises a line winding body around which a fishing line is wound by a winding operation of an operating part; and a spool shaft that is provided between the left and right side panels and has an outer peripheral face to which the spool is integrally fixed, and comprises a first pin embedded in the spool shaft and the spool to extend from the spool shaft to the spool, and a second pin configured to cover a first end of the first pin and fixed in the spool to extend from the spool to the spool shaft.

In the fishing reel according to the embodiment of the present invention, a part of the first pin is embedded on a first side of the spool as viewed in a radial direction of the spool, and a part of the second pin is fixed on a second side of the spool as viewed in the radial direction of the spool.

In the fishing reel according to the embodiment of the present invention, the first pin is made of stainless steel.

In the fishing reel according to the embodiment of the present invention, the first pin is made of a material having a higher hardness than that of the spool.

In the fishing reel according to the embodiment of the present invention, the first pin is provided to extend in a direction perpendicular to the spool shaft or in a direction inclined to the spool shaft.

In the fishing reel according to the embodiment of the present invention, a plurality of the first pins are provided, and a plurality of the second pins as many as the first pins are provided.

In the fishing reel according to the embodiment of the present invention, the second pin comprises a fishing line locking portion configured to lock the fishing line at one end.

In the fishing reel according to the embodiment of the present invention, the second pin is made of aluminum.

In the fishing reel according to the embodiment of the present invention, the second pin comprises a large-diameter portion, and the second pin is press-fitted and fixed to the spool by way of the large-diameter portion.

In the fishing reel according to the embodiment of the present invention, the second pin has a surface subjected to alumite treatment.

In the fishing reel according to the embodiment of the present invention, the first pin and the second pin are provided to be coaxial.

In the fishing reel according to the embodiment of the present invention, each of the spool and the spool shaft has an embedded hole into which the first pin is embedded, and an adhesive is provided between an outer face of the first pin and a surface defining the embedded hole of each of the spool and the spool shaft.

The fishing reel according to the embodiment of the present invention further comprises a third pin that covers a second end of the first pin on an opposite side from the first end and is fixed in the spool to extend from the spool to the spool shaft.

According to the above embodiment, it is possible to provide the fishing reel capable of suppressing idling between the spool and the spool shaft even when strong tension is generated in the spool during fishing.

### BRIEF DESCRIPTION OF THE DRAWINGS

FIG. 1 is a view illustrating a basic configuration of a fishing reel according to an embodiment of the present invention;

FIG. 2A is a perspective view of a spool fixed to a spool shaft in a fishing reel according to the embodiment of the present invention; FIG. 2B is a front view of the spool fixed to the spool shaft in the fishing reel according to the embodiment of the present invention; and FIG. 2C is a cross-sectional view of the spool fixed to the spool shaft in the fishing reel according to the embodiment of the present invention.

### DETAILED DESCRIPTION

Hereinafter, an embodiment of a fishing reel according to the present invention will be specifically described with reference to the accompanying drawings while a dual-bearing reel is taken as an example. Constituent elements common in a plurality of drawings are assigned with the same reference numerals throughout the plurality of drawings. It should be noted that each drawing is not necessarily drawn to an accurate scale for convenience of description.

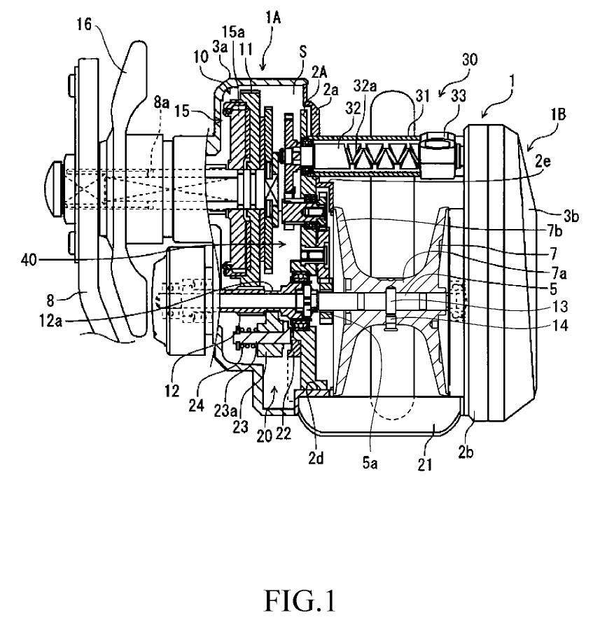

First, a basic configuration of the fishing reel according to the embodiment of the present invention will be described with reference to FIG. 1. FIG. 1 is a view illustrating a basic configuration of a fishing reel according to the embodiment of the present invention.

A fishing reel 10 according to the embodiment of the present invention comprises a reel body 1 comprising left and right frames 2a and 2b and left and right side panels 1A and 1B covering the left and right frames 2a and 2b with left and right side plates (left and right covers) 3a and 3b. A spool shaft 5 is rotatably supported between the left and right side panels 1A and 1B by way of a bearing (not illustrated), and a spool 7 around which a fishing line is wound is integrally fixed to the spool shaft 5. The spool 7 comprises a line winding body 7a and flanges 7b integrally formed on both left and right sides thereof, and the fishing line is wound around the line winding body 7a while being restricted by the left and right flanges 7b.

In the fishing reel 10 according to the embodiment of the present invention, a set plate 2A is provided, constitutes a frame structure together with the left frame 2a described above, and may be integrally attached to the left side plate (left cover) 3a. In this case, when the left side plate 3a is detached from the left frame 2a, the set plate 2A is also integrally detached from the left side plate 3a, a spool opening 2d formed in the left frame 2a can be exposed, the spool 7 can be easily detached, and the maintainability can be improved.

As described above, the spool 7 comprises the line winding body 7a and the flanges 7b integrally formed on both left and right sides thereof, and is configured in a substantially cylindrical shape, and can wind the fishing line around the outer periphery of the line winding body 7a when being rotated forward. One of a pair of bearings (not illustrated) rotatably supporting the spool 7 is fixed to the left frame 2a of the reel body 1, and the other is fixed to the set plate 2A.

The set plate 2A can be fixed to the left frame 2a by screwing (a screw) to be described later. In addition, the spool 7 and the set plate 2A may be attached to and detached from the left frame 2a by adopting a bayonet structure in which a plurality of claws provided on a lock member are rotated to lock to a holding part provided on the frame 2, and a method such as bonding may be used for fixing. When the set plate 2A is fixed to the left frame 2a, the spool 7 is rotatably and pivotally supported. In addition, a fixed magnet and a movable magnet (not illustrated) are held on the set plate 2A to constitute a braking part (not illustrated).

The left and right frames 2a and 2b (the reel body 1) may be attached to a fishing rod, and the fishing reel 10 comprises an operation means (handle) 8 as is the case with a conventional fishing reel and may wind the fishing line when the spool 7 is rotated in a forward direction by a user operation. Note that some known functions of the reel body are omitted in order to simplify the description.

In addition, the handle 8 that rotationally drives the spool 7 is installed on the left side panel 1A side, and a known power transmission mechanism for spool 10 that transmits a rotational driving force of the handle 8 to the spool shaft 5 is disposed in a space (gear box) S between the left frame 2a and the left side plate 3a. The power transmission mechanism for spool 10 comprises a drive gear 11 rotatably supported by a handle shaft 8a to which the handle 8 is attached, and a pinion gear 12 axially held by the spool shaft 5 and meshed with the drive gear 11.

The drive gear 11 is provided with a known drag mechanism 15 that frictionally engages between the handle shaft 8a and the drive gear 11 to generate a predetermined braking force on the drive gear. The braking force can be adjusted by rotationally operating a drag knob (also referred to as a star drag) 16 attached to the handle shaft 8a and changing a pressure contact force of a brake plate 15a in surface contact with the drive gear 11.

The fishing reel 10 comprises a clutch mechanism (clutch means) 20, and a user can select connection and disconnection for power transmission with respect to the spool 7 by operating a switching operation member 21 of the clutch mechanism (clutch means) 20. In a connection state, winding by the operation means is possible. In a disconnection state, the spool 7 can be freely rotated in forward and backward directions, and the fishing line can be released.

In addition, a level wind device 30 is disposed between the left and right side panels 1A and 1B on a side of the spool 7 in a fishing line payout direction. The level wind device 30 comprises a cylindrical shaft 31 fixed between the left and right side panels, a drive shaft 32, which is rotatably disposed in the cylindrical shaft 31 and has a spiral groove 32a formed on the outer periphery, and a fishing line guide 33 through which the fishing line is inserted, the fishing line guide 33 being unrotatably fixed to the cylindrical shaft 31 and comprising an engagement pin (not illustrated) engaged with the spiral groove 32a. The drive shaft 32 is driven to rotate by a power transmission mechanism for level wind 40 disposed in the gear box. Further details are omitted.

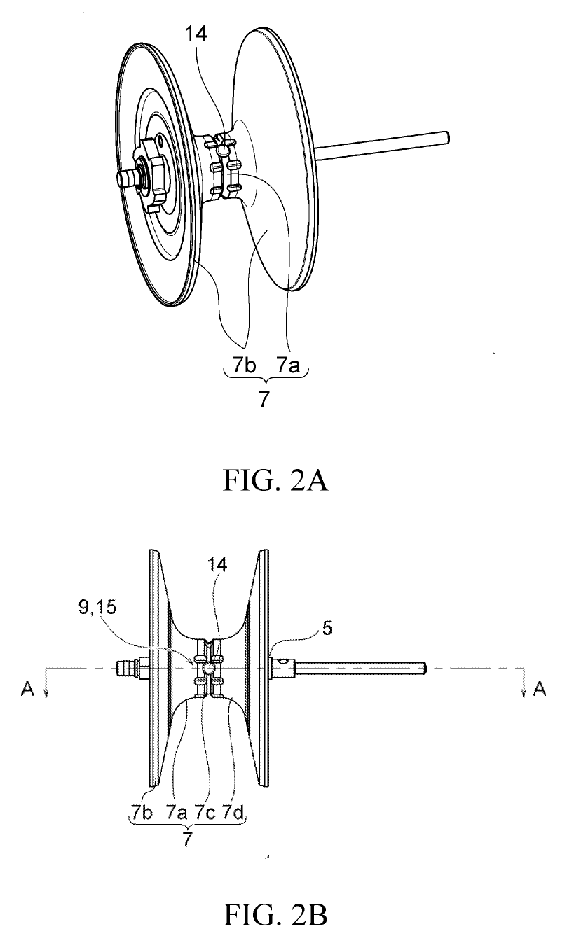

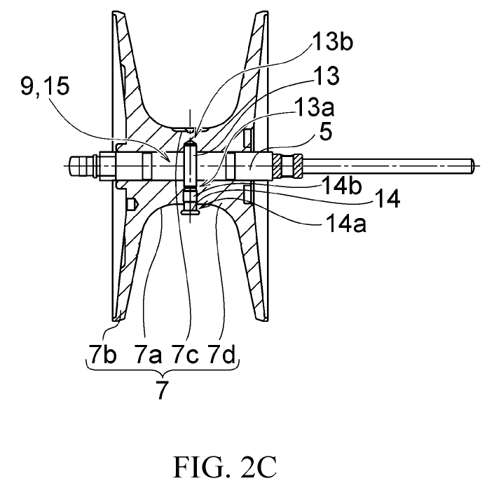

Next, the fishing reel 10 according to the embodiment of the present invention will now be further described with reference to FIGS. 1 to 2C.

FIG. 2A is a perspective view of the spool fixed to the spool shaft in the fishing reel according to the embodiment of the present invention, FIG. 2B is a front view of the spool fixed to the spool shaft in the fishing reel according to the embodiment of the present invention, and FIG. 2C is a cross-sectional view (cross-sectional view taken along line A-A illustrated in FIG. 2B) of the spool fixed to the spool shaft in the fishing reel according to the embodiment of the present invention.

As illustrated in the drawings, the fishing reel 10 according to the embodiment of the present invention is the fishing reel 10 comprising: the reel body 1 comprising the left and right side panels 1A and 1B; the spool 7 that is provided between the left and right side panels 1A and 1B and comprises the line winding body 7a around which the fishing line is wound by a winding operation of an operating part 8; and the spool shaft 5 that is provided between the left and right side panels 1A and 1B and has an outer peripheral surface to which the spool 7 is integrally fixed, and comprises a first pin 13 embedded in the spool shaft 5 and the spool 7 (inside the spool shaft 5 and the spool 7) to extend from the spool shaft 5 to the spool 7 and a second pin 14 fixed in the spool 7 (inside the spool 7) to cover a first end 13a of the first pin 13 and extend from the spool 7 to the spool shaft 5. More preferably, the first pin 13 is embedded in the spool shaft 5 and the spool 7 (inside the spool shaft 5 and the line winding body 7a of the spool 7) to extend from the spool shaft 5 to the spool 7, and the second pin 14 is fixed in the spool 7 (inside the line winding body 7a of the spool 7) to cover the first end 13a of the first pin 13 and extend from the spool 7 to the spool shaft 5. Note that it suffices that the first pin 13 is embedded in the spool shaft 5 to extend from the spool shaft 5 to the spool 7 and is embedded in at least a part of the spool 7 (inside the line winding body 7a of the spool 7). As described later, the first end 14a of the second pin 14 (the end on the outer side of the spool 7) may be arranged and fixed to be exposed from the spool 7.

According to the fishing reel 10 of the embodiment of the present invention, it is possible to provide the fishing reel capable of suppressing idling between the spool and the spool shaft even when strong tension is generated in the spool during fishing. More specifically, it is possible to provide the fishing reel in which the first pin is arranged across the spool and the spool shaft, and thus can serve as a wedge for both the members, the first pin improves a fixing force (in a rotation direction) between the spool and the spool shaft so that breakage is less likely to occur, and the second pin is provided to cover the first pin so that it is possible to prevent corrosion of the first pin and contribute to improvement of the fixing force (in the rotation direction) between the spool and the spool shaft.

In the fishing reel 10 according to the embodiment of the present invention, a part of the first pin 13 is embedded in a first side 7c of the spool 7 as viewed in a radial direction of the spool 7, and a part of the second pin 14 is fixed to a second side 7d of the spool 7 as viewed in the radial direction of the spool 7. In this manner, the first pin 13 and the second pin 14 can be more accurately and reliably arranged or fixed to both the spool 7 and the spool shaft 5. In the illustrated example, a part of the first pin 13 is configured to be embedded over both the first side 7c and the second side 7d of the spool 7 as viewed in the radial direction of the spool 7, whereby the fixing force of the first pin 13 in the rotational direction between the spool 7 and the spool shaft 5 can be more accurately and reliably improved.

In the fishing reel 10 according to the embodiment of the present invention, the first pin 13 is made of stainless steel. This makes it possible to improve the fixing force between the spool 7 and the spool shaft 5 in the rotation direction. Here, the spool is usually made of an aluminum material, but is not limited thereto. In addition, the spool shaft is usually made of stainless steel, but is not limited thereto. Furthermore, the second pin 14 is made of, for example, an aluminum material, but is not limited thereto.

In the fishing reel 10 according to the embodiment of the present invention, the first pin 13 is made of a material having a higher hardness than that of the spool 7. Examples of such a material include, but are not limited to, brass, a titanium alloy, and an aluminum alloy. It should be understood that the hardness referred to herein refers to hardness based on Vickers hardness (HV). This makes it possible to improve the fixing force between the spool 7 and the spool shaft 5 in the rotation direction.

In the fishing reel 10 according to the embodiment of the present invention, the first pin 13 is provided to extend in a direction perpendicular to the spool shaft 5 or in a direction inclined to the spool shaft 5. As described above, it suffices that the first pin 13 is embedded in the spool shaft 5 to extend from the spool shaft 5 to the spool 7 and is embedded in (to traverse or cross) at least a part of the spool 7 (the inside of the line winding body 7a of the spool 7), and thus is not limited to a specific inclination angle. In this manner, the fixing force can be reliably improved even when the spool shaft has a thinner shape.

In the fishing reel 10 according to the embodiment of the present invention, a plurality of the first pins 13 are provided, and a plurality of the second pins 14 as many as the first pins 13 are provided. This makes it possible to provide the fishing reel in which the fixing force (in the rotation direction) between the spool and the spool shaft is further improved by the first pins so that breakage is less likely to occur, and the second pins are provided to cover the first pins so that it is possible to prevent corrosion of the first pins and contribute to further improvement of the fixing force (in the rotation direction) between the spool and the spool shaft.

In the fishing reel 10 according to the embodiment of the present invention, the second pin 14 comprises a fishing line locking portion configured to lock the fishing line at the first end 14a. In this manner, it is possible to provide the fishing reel in which the second pin can prevent the corrosion of the first pin, contributes to improvement of the fixing force (in the rotation direction) between the spool and the spool shaft, and has a function as a locking pin by providing the second pin with the fishing line locking portion that locks the fishing line.

In the fishing reel 10 according to the embodiment of the present invention, the second pin 14 is made of aluminum. This makes it possible to provide the fishing reel in which the second pin covering the first pin can have a function of preventing the corrosion of the first pin without corrosion and also contributes to improvement of the fixing force (in the rotation direction) between the spool and the spool shaft.

In the fishing reel 10 according to the embodiment of the present invention, the second pin 14 comprises a large-diameter portion 14b, and the second pin 14 is press-fitted and fixed to the spool 7 by way of the large-diameter portion 14b. Here, the large-diameter portion 14b refers to a portion constituting a fitting portion with respect to the spool 7. This makes it possible to reliably fix the second pin 14 to the spool 7.

In the fishing reel 10 according to the embodiment of the present invention, the second pin 14 has a surface subjected to alumite treatment. This makes it possible to reduce the corrosion of the second pin.

In the fishing reel 10 according to the embodiment of the present invention, the first pin 13 and the second pin 14 are provided to be coaxial. This makes it possible to prevent the corrosion of the first pin 13.

In the fishing reel 10 according to the embodiment of the present invention, an embedded hole 9 into which the first pin 13 is embedded is formed in each of the spool 7 and the spool shaft 5, and an adhesive 15 is provided between an outer face of the first pin 13 and a surface defining the embedded hole 9 of each of the spool 7 and the spool shaft 5. This makes it possible to eliminate a gap or play in the embedded hole 9 of the first pin 13 and to reduce abnormal noise. Here, the size of the embedded hole 9 varies depending on a dimension of the first pin 13 to be embedded, and is in the range of a diameter φ of 1 mm to 5 mm, and for example, the diameter φ of 2.5 mm is conceivable. However, the diameter of the first pin is not intended to be limited thereto.

The fishing reel 10 according to the embodiment of the present invention may further comprise a third pin (not illustrated) that covers a second end 13b of the first pin 13 on an opposite side from the first end 13a and is fixed in the spool 7 to extend from the spool 7 to the spool shaft 5. This makes it possible to increase the fixing force (in the rotation direction) between the spool and the spool shaft even when the spool 7 and the spool shaft 5 do not adhere to each other.

Dimensions, materials, and arrangements of the constituent elements described in this specification are not limited to those explicitly described in the embodiment, and the constituent elements may be modified to have any dimensions, materials, and arrangements that may fall within the scope of the present invention. In addition, constituent elements not explicitly described herein can be added to the described embodiment, or some of the constituent elements described in the embodiment can be omitted.

What is claimed is:

1. A fishing reel comprising:
a reel body provided with left and right side panels;
a spool that is provided between the left and right side panels and comprises a line winding body around which a fishing line is wound by a winding operation of an operating part;
a spool shaft that is provided between the left and right side panels and has an outer peripheral face to which the spool is integrally fixed, wherein
a first pin is embedded in the spool shaft and the spool to extend from the spool shaft to the spool; and
a second pin covers a first end of the first pin and is fixed in the spool to extend from the spool to the spool shaft.

2. The fishing reel according to claim 1, wherein a part of the first pin is embedded on a first side of the spool as viewed in a radial direction of the spool, and a part of the second pin is fixed on a second side of the spool as viewed in the radial direction of the spool.

3. The fishing reel according to claim 1, wherein the first pin is made of stainless steel.

4. The fishing reel according to claim 1, wherein the first pin is made of a material having a higher hardness than a material of the spool.

5. The fishing reel according to claim 1, wherein the first pin is provided to extend in a direction perpendicular to the spool shaft or in a direction inclined to the spool shaft.

6. The fishing reel according to claim 1, wherein a plurality of the first pins are provided, and a plurality of the second pins as many as the first pins are provided.

7. The fishing reel according to claim 1, wherein the second pin comprises a fishing line locking portion configured to lock the fishing line at one end.

8. The fishing reel according to claim 1, wherein the second pin is made of aluminum.

9. The fishing reel according to claim 1, wherein the second pin comprises a large-diameter portion, and the second pin is press-fitted and fixed to the spool by way of the large-diameter portion.

10. The fishing reel according to claim 1, wherein the second pin has a surface subjected to alumite treatment.

11. The fishing reel according to claim 1, wherein the first pin and the second pin are provided to be coaxial.

12. The fishing reel according to claim 1, wherein each of the spool and the spool shaft has an embedded hole into which the first pin is embedded, and an adhesive is provided between an outer face of the first pin and a surface defining the embedded hole of each of the spool and the spool shaft.

13. The fishing reel according to claim 1, further comprising a third pin configured to cover a second end of the first pin on an opposite side from the first end and fixed in the spool to extend from the spool to the spool shaft.
